(19) United States
(12) Patent Application Publication
(10) Pub. No.: US 2003/0101048 A1
(43) Pub. Date: May 29, 2003

(54) Suppression system of background noise of voice sounds signals and the method thereof

(75) Inventor: Chia-Horng Liu, Taoyuan Hsien (TW)

Correspondence Address: BACON & THOMAS, PLLC, 625 SLATERS LANE, FOURTH FLOOR, ALEXANDRIA, VA, 22314

(73) Assignee: Chunghwa Telecom Co., Ltd., Taoyuan Hsien (TW)

(21) Appl. No.: 09/984,544

(22) Filed: Oct. 30, 2001

(51) Int. Cl. G10L 13/08

(52) U.S. Cl. 704/208

(57) ABSTRACT

A kind of suppression system of background noise of voice sounds signals, the adaptive filter of the long-time and short-time statistic characteristics of the voice sounds, since the statistic characteristics of the voice sounds signals varies as time goes by, the association coefficients of the filter also have to be adjusted according to the variation of the voice sounds signals to eliminate the unnecessary background noise, next to compensate for the high frequency attenuation of the voice sounds signals by passing through the high frequency booster so as to elevate the degree of brightness of the voice sounds signals and to acquire the voice sounds with the best quality.

### BACKGROUND OF THE INVENTION

1. Field of the Invention

This invention relates to a kind of suppression system of background noise of voice sounds signals and the method thereof, which is mainly focusing on the suppression system of background noise designed aiming at the short time and long time characteristic of voice sounds and the method thereof.

2. Description of the Prior Art

The voice sounds signal is the major data type transmitted in the telecommunication system. During the process of communication, in addition to the voice sounds, the background noise of the telecommunication environment also accompanies to enter into the telephone so that it will cause interference with some degree and further it influences the quality of the telecommunication; especially the rapid-growing mobile phone recently is easily influenced by the background noise. So the technology of suppression background noise is one important topic in the current telecommunication system of which it emphasizes the quality. There are three kinds of technology common used for the suppression background noise as follows:

The first method is the method of deleting the noise in the frequency domain. The basic principle of this method is to estimate the energy of the noise at frequency domain in the segment of non-voice sounds, next to eliminate the estimated energy of the noise at each frequency beforehand in the frequency domain in the following voice sounds segment. Although this method is simple, since the statistic characteristics of the general background noise varies with time, its effect of suppression the background noise is limited. There mentioned the concept of using the method of suppression the noise in frequency domain in U.S. Pat. No. 06,175,602 and U.S. Pat. No. 05,742,927.

The second method is the method of deleting the background noise in time domain. The basic principle of this method is by utilizing two microphones to receive the outside signals. The Primary microphone is used to receive speaker's voice along with the background noise. The secondary microphone is used to receive the background noise only. Thus, the background noise could be estimated through the secondary microphone. Next, by subtracting the estimated background noise from the signal of the first microphone in the time domain, the better quality of the voice sounds signals could be obtained. However, this method requires two microphones and the distance between these two microphones should be far enough, which is basically nearly impossible for the application in the mobile phone.

The third method is the periodic tracking. The basic principle of this method is to estimate and track the periods in the voice sounds signal first, next to find the average of the related signals within a few periods. The speech enhancement is achieved by averaging the delayed and weighted versions of input speech signal, where the delay lengths correspond to the detected pitch periods. Since background noise does not possess the same pitch periods as original speech, it is cancelled out by this operation. There mentioned the concept of using the subtracting with periodic, tracking in U.S. Pat. No. 05,598,158.

It could be found from the above-mentioned that there still are many drawbacks in the above-mentioned technologies and there is a urgent need for improvement.

The inventor of this invention, due to understanding all the drawbacks of the above-mentioned traditional technologies, tries his best to think how to better and innovate them and studies hard for many years. Finally he succeeds in researching and developing the suppression system of background noise of voice sounds signal and the method thereof.

### SUMMARY OF THE INVENTION

The purpose of this invention is to provide one suppression system and method of suppression background noise of voice sounds signals wherein it constructs the model of the voice sounds signal by utilizing one all-pole linear predict filter on the one hand; on the other hand it also detects the pitch periods which only exist in the voice sounds signals, and it reduces the background noise according to the estimated voice sounds signals association coefficients and the estimated voice sounds pitch periods which further enhances the quality of the voice sounds signals.

One another purpose of this invention is to provide a kind of system of suppression background noise of voice sounds signals and the method there of which could largely elevate the quality of the input signals with low signal-to-noise ratio as well as adjust the related coefficients adaptively.

One another purpose of this invention is to provide a kind of system of suppression background noise of voice sounds signals and the method thereof which has low degree of complexity and requires only one microphone so that it is fairly suitable to be used in the recently-fast-growing mobile phone and the technology of the voice sounds recognition so as to enhance the quality of the voice sounds coding and the recognition rate of voice sounds signals.

The background noise suppression system of voice sounds is used to enhance the decrease of the voice sounds quality caused by the influence of the background noise. The analog voice sounds are transformed into the digital ones first through the sampling unit for further digital signal processing. The bandwidth of the voice sounds is about 4 KHz. According to the Nyquist sampling principle, the minimum required sampling frequency is 8 KHz. In order to elevate the degree of correlation between these sampling signals, the sampling frequency is increased from 8 KHz to 32 KHz, which is called “oversamping”. The digital signals after sampling are represented using the 12 bits pulse Code Modulation (PCM) technology. That is to say, the allowable variation range of the digit sounds samples is within ±2048.

The system and the method of suppression background noise of voice sounds signals of this invention comprises: one oversampling unit, two low-pass filter units, one adaptive speech analysis unit, one pitch detection unit, one background noise suppression unit, and one high-frequency booster unit. Let us assumed that the voice sounds containing the background noise is Sₙ(t); first Sₙ(t) is oversampled by the oversampling unit with a sampling rate that is much higher than the Nyquist rate to increase the correlation between speech samples., next to represent the digit signals Sₙ(k) acquired by oversampling with 12 bits pulse code modulation, wherein k represents the k- the sampling signal. Due to the effect of oversamping unit, it is required to remove unnecessary signals outside the voice sounds bandwidth by the use of a low-pass filter. The digital signal, Sₙₙ(k), through the first low-pass filter is sent into the adaptive speech analysis unit, the pitch detection unit, and the background noise suppression unit, respectively, to proceed the process of next step. In adaptive speech analysis unit, it utilizes the N'th order all-pole adaptive filter to estimate the voice sounds signal. The coefficients of the all-pole adaptive filter is aₗ(k), i={1,2, . . . N}, which is determined to represent the unique characteristics of the voice sounds, will be sent into the background noise suppression unit; on the other hand, Sₙₙ(k) will be sent into the pitch detection unit to estimate the pitch periods of the voice sounds signal wherein the estimated pitch period P range is within 3-10 ms. If the sampling frequency is 32 KHz, then the number of the samples in correspondence with one pitch period is about 96-320. The pitch periods of each voice sounds signals will be estimated and sent to the background noise suppression unit to proceed the next step suppression of the background noise.

In the suppression filter unit, it utilizes the filter coefficient, aₗ(k), and the voice sounds pitch period, P, estimated from the adaptive speech analysis unit and the pitch detection unit, respectively, to design the background noise suppression unit. The Sₙₙ(k) from the first low-pass filter is sent into the background noise suppression unit at this time designed by the inventor to reduce the energy of the background noise embedded in the voice sounds signals and enhance the voice sounds-to-noise ratio. Since the high-frequency components in the original voice sounds signals are also suppressed by the background noise suppression unit, we design another high-frequency booster to compensate for the suppression component of high frequency in the voice sounds signals. Finally, another low-pass filter is used to filter the noise outside the bandwidth of the voice sounds signals. The voice sound signal, Ŝₙ(k), with elevated quality is thus acquired.

### BRIEF DESCRIPTION OF THE DRAWINGS

The drawings disclose an illustrative embodiment of the present invention which serve to exemplify the various advantages and objects hereof, and are as follows:

FIG. 1 is the schematic diagram of the suppression system of the voice sounds background noise of this invention;

FIG. 2 is the circuit block diagram of the adaptive speech analysis unit of said suppression system of the voice sounds background noise;

FIG. 3 is the circuit block diagram of the adaptive prediction filter coefficient of said suppression system of the voice sounds background noise;

FIG. 4 is the circuit block diagram of the pitch detection unit of said suppression system of the voice sounds background noise; and

FIG. 5 is the circuit block diagram of the background noise suppression unit of said suppression system of the voice sounds background noise.

### REPRESENTATIVE SYMBOL OF MAJOR PARTS

101 oversamping unit

102 low-pass filter

103 adaptive speech analysis unit

104 background noise suppression unit

105 pitch detection unit

106 high-frequency booster

107 low-pass filter

21 hand limiter

221 adaptive stepsize decision unit

23 adaptive prediction filter

31 hard limiter

41 pitch decision unit

51 noise shaping filter

### DETAILED DESCRIPTION OF THE PREFERRED EMBODIMENT

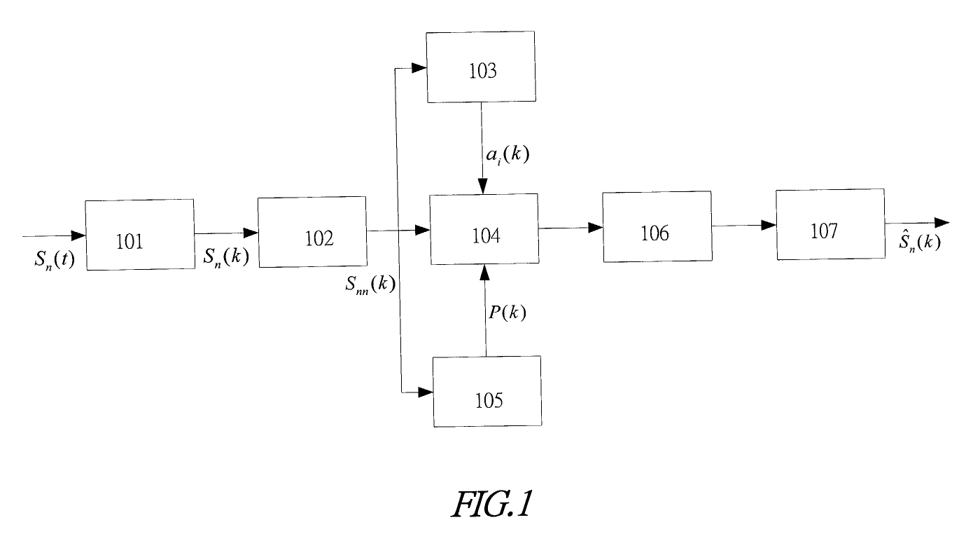

Please refer to FIG. 1, the suppression system of background noise of voice sounds signals of this invention comprises: one oversamping unit 101, two low-pass filters 102, 107, one adaptive speech analysis unit 103, one pitch detection unit 105, one background noise suppression unit 104, and one high-frequency booster 106. Before proceeding suppression treatment of background noise, it will be pre-treated first to transform the analog voice sound signal into the digital signal which is suitable for further processing including oversampling unit and low-pass filter; The oversampling unit 101 on one hand performs analog-to-digital transformation on analog voice sounds signal and on the other hand represents the transformed digital signal with pulse code modulation (PCM) technique. On proceeding analog-to-digital transformation, the sampling frequency is far larger than the minimum frequency regulated by the sampling principle to enhance the correlation between samples. In this embodiment, the suggested sampling frequency is 32 Hz, which is 8 times of the bandwidth of the general voice sounds bandwidth, 4 KHz. Low-pass filter 102 is used to remove the noise outside the bandwidth of the voice sounds, especially that the oversampled signals are passed through oversampling unit 101 and it is necessary to limit the bandwidth of the signal within the bandwidth of the voice sounds with one low-pass filter 102 to elevate the performance of the following process units. In this embodiment, it adopts one three-order Butterworth low-pass filter wherein the cut-off frequency is designed at the bandwidth of the voice sounds, which is 4 KHz. The signal Sₙₙ(k) from the low-pass filter is sent into the adaptive speech analysis unit 103, the pitch detection unit 105, and the high-frequency booster 106, respectively, to proceed the next-stage process.

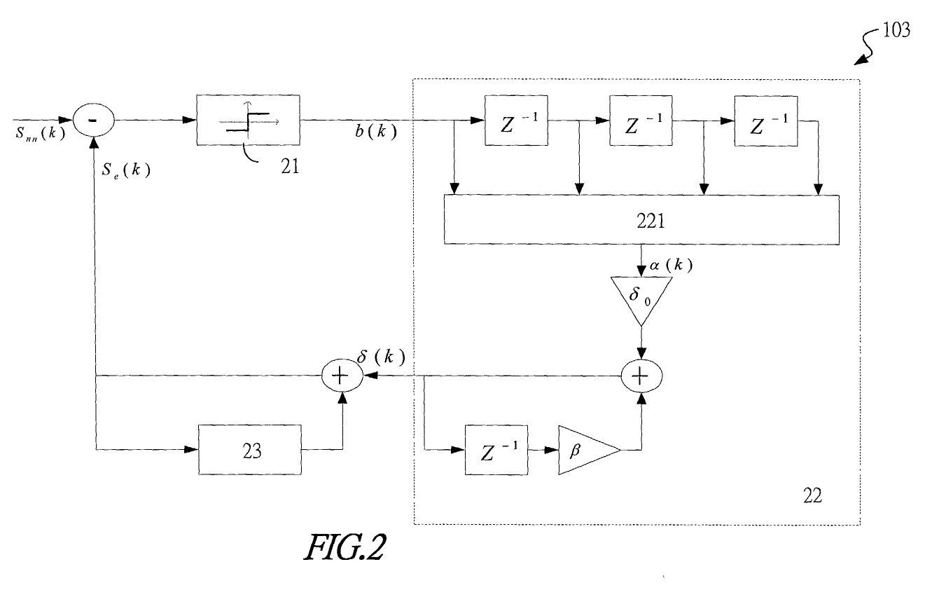

FIG. 2 is the circuit block diagram of the adaptive speech analysis unit. The adaptive speech analysis unit 103 comprises one hard limiter 21, one stepsize estimation unit 22, and one adaptive prediction filter 23. The hard limiter 21 decides the output bit, b(k), by comparing the input speech sample, Sₙₙ(k), and the prediction Sₑ(k) from the adaptive prediction filter 23, as shown in the following equation:

$$b ( k ) = \{ \begin{matrix} 1 , if {S}_{nn} ( k ) > {S}_{e} ( k ) \\ - 1 , if {S}_{nn} ( k ) < {S}_{e} ( k )\end{matrix} \qquad ( 1 )$$

The stepsize estimation unit 22 estimates the stepsize of the current samples by utilizing the bit determined beforehand. The estimated stepsize is used to compensate for the residual signal, which is the unpredicted part of the last prediction sample. Let us assume that the currently determined bit is b(k), then the adaptive stepsize decision unit 221 in the step estimation unit 22 will determine the current status of the adaptive speech analysis unit 103 according to b(k) and its preceding three bits, b(k−1), b(k−2), and b(k−3), and determine one correction coefficient, α(k),, as shown in Table 1. Next, it produces one estimated stepsize, δ(k), by utilizing one first-order feedback average unit at time point k as represented as follows:

δ(k)=β*δ(k−1)+δ₀*α(k) (2)

wherein β<1 is the constant of the feedback average unit and is used to control the average length. δ₀ is a constant and is used to adjust the value of the correction coefficient α(k) so that the adaptive speech analysis unit 103 could adapt to the variation of the voice sounds signals. Finally, the N'th-order adaptive prediction filter 23 produces the estimated value Sₑ(k+1) for the next speech sample by combining the last N prediction samples and the estimated stepsize δ(k), as shown in the following equation:

$${S}_{e} ( k + 1 ) = {\sum }_{i = 0}^{N - 1} {a}_{l} ( k ) * {S}_{e} ( k - i ) + δ ( k ) \qquad ( 3 )$$

Table 1 is the reference table of the adaptive stepsize decision unit 221. The correction coefficient α(k) is determined according to this table. If the four consecutive bits are the same, it means that the Sₑ(k) value estimated by the adaptive speech analysis unit 103 is not enough, so the correction coefficient α(k) is set to be 2 such that the adaptive speech analysis unit 103 could adapt to the variation of the voice sounds signals rapidly. If only three consecutive bits are the same, a smaller correction coefficient α(k)=1 is given to slightly increase the stepsize. If any two successive bits of these four bits are different, reset the correction coefficient as −1. This is because at this time the adaptive speech analysis unit 103 over-estimates the voice sounds signal and the stepsize is required to be decreased. For the other conditions, α(k)=0, which represents the status that the adaptive speech analysis unit 103 could adapt to the variation of the voice sounds signals.

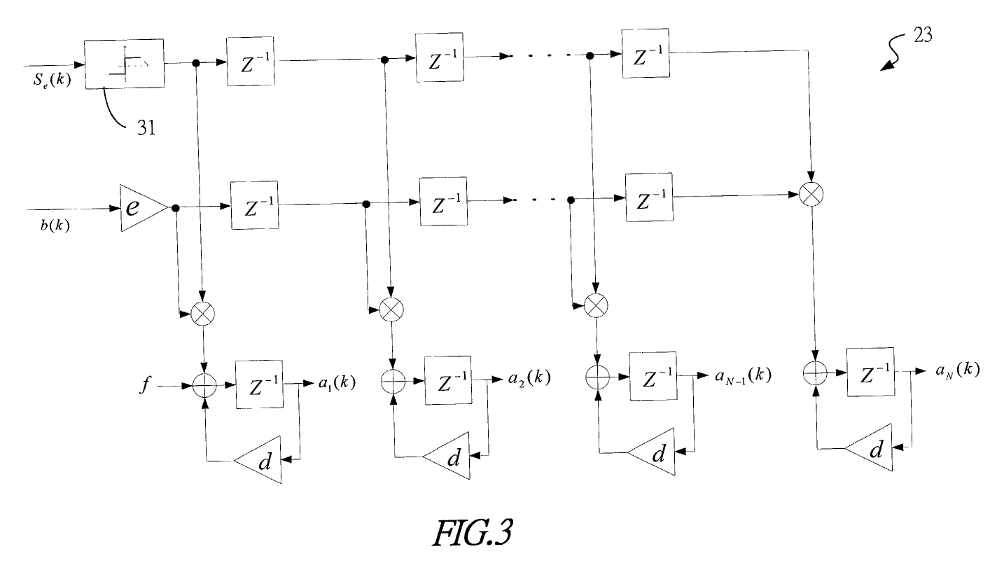

FIG. 3 is the circuit block diagram of the coefficients estimation of the adaptive prediction filter 23, which is used to produce N coefficients of N'thorder adaptive prediction filter coefficient 23, aₗ(k), i=1,2, . . . N. The block diagram of the adaptive prediction filter coefficient 23 comprises one hard limiter 31, two rows of tapping delay lines with the length of N−1, one row of first order feedback average unit with the length of N, a multiplier line of length N−1, and an amplifier. Two input signals include the voice sounds signals estimated signal Sₑ(k) and the digital bit b(k). First of all, the prediction Sₑ(k) is sent into the hard limiter 31 to decide the sign of Sₑ(k). The output of the hard limiter 31 is +1 or −1. Afterward, the last N hard-limited prediction values are stored in the delay line 1. For b(k), it is amplified with a constant gain 0<e<1 and sent into delay line 2 to store the last N amplified bits. Finally, the estimated adaptive prediction filter coefficients aₗ(k), i=2,3, . . . N are generated with the multiplier line and the coefficients filter bank according to the following equation:

aₗ(k)=d*aₗ(k−1)+e*b(k)*SGN[Sₑ(k)] (4)

wherein d is a constant which represents the average length of the first order feedback average unit. The heuristic value of d is 0.9. SGN[ ] represents the operation of the hard limiter 31. Basically, equation (4) represents a simplified stochastic gradient-based algorithm. It is noted that the generation of a₀(k) is modified according to the following equation:

a₀(k)=d*a₀(k−1)+e*b(k)*SGN[Sₑ(k)]+f (5)

,where f>0 is a constant and is used to emphasize the high correlation between the current speech sample and the latest one.

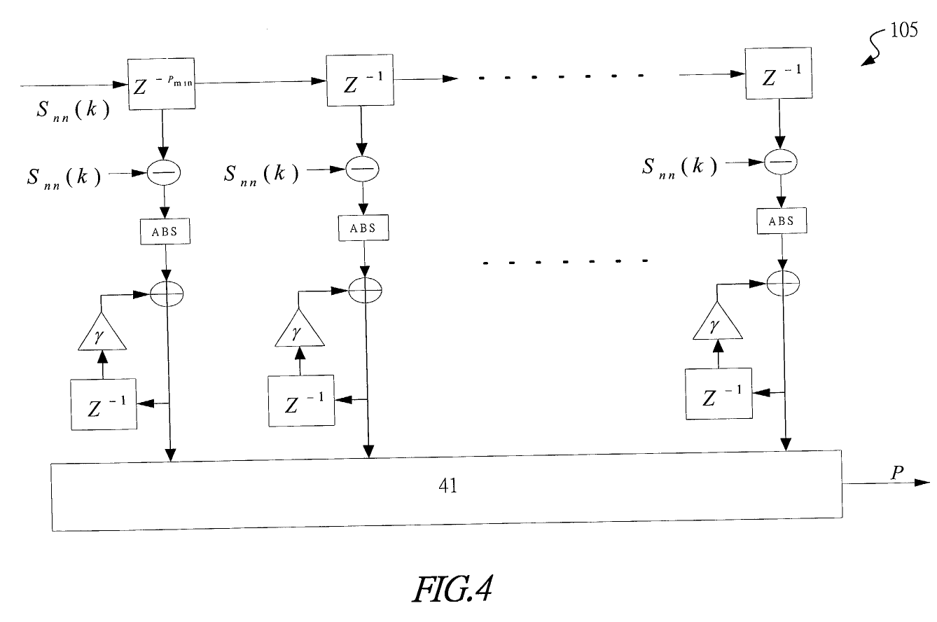

FIG. 4 is the circuit block diagram of the pitch detection unit, which is used to estimate the pitch periods of the voice sounds signals. The pitch detection unit 105 comprises one row of tapping delay lines with the length of (Pₘₐₓ−Pₘᵢₙ+1), the subtraction line with a length of (Pₘₐₓ−Pₘᵢₙ+1), the absolute value line with a length of (Pₘₐₓ−Pₘᵢₙ+1), a pitch filter bank with a length of (Pₘₐₓ−Pₘᵢₙ+1), and one pitch decision unit 41. Pₘₐₓ represents the maximum possible pitch period of the voice sounds, Pₘᵢₙ represents the minimum possible pitch period of the voice sounds. If the sampling frequency is 32 KHz, then Pₘₐₓ≈320, Pₘᵢₙ≈96 so that the length of the tapping delay lines, subtraction line, absolute value line, and the number of first-order feedback average units is 225. First of all, the input samples Sₙₙ(k)'s are sent into the delay line to store the last (Pₘₐₓ−Pₘᵢₙ+1) values. On the other hand, Sₙₙ(k)'s are subtracted by its delayed versions at the subtraction line. Following that, the absolute values from the subtraction line are sent into a pitch filter bank to average the correlation between Sₙₙ(k)'s and its delay versions. The above-mentioned operation is to search the degree of correlation between Sₙₙ(k) and its proceeding samples. Assume the correlation between Sₙₙ(k) and Sₙₙ(k−P) is the highest, then the smallest value of the output of the pitch filter corresponds to the Pth delay unit. Therefore, in the pitch decision unit 41, the desired pitch period P is detected according to the following equations:

$$\begin{matrix}P = {arg}_{{P}_{min} \leq i \leq {P}_{max}} \{ min ( E [ \vert {S}_{nn} ( k ) - {S}_{nn} ( k - i ) \vert ] ) \} , if min ( E [ \vert {S}_{nn} ( k ) - {S}_{nn} ( k - i ) \vert ] ) \leq {E}_{th} & ( 6 ) \\ P = 0 , if min ( E [ \vert {S}_{nn} ( k ) - {S}_{nn} ( k - i ) \vert ] ) > {E}_{th} & ( 7 )\end{matrix}$$

wherein E[ ] represents the operation of a first-order pitch filter and

$${arg}_{{P}_{min} \leq i \leq {P}_{max}} \{ min ( ) \}$$

represents the selection of the parameter which makes the value within the bracket minimum. Eₜₕ is a threshold value of the output value of the pitch filter which is one empirical value used to distinguish between vowel and non-vowel samples. If the current sample does not belongs to the vowel in the voice sounds signals, the detected P=0.

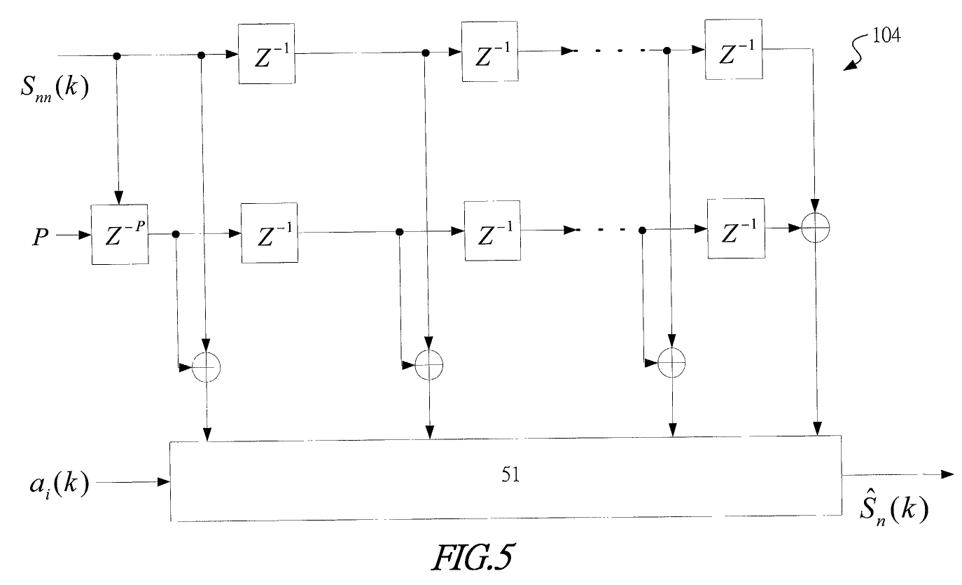

FIG. 5 is the circuit block diagram of the background noise suppression unit which is used to combine the voice sounds characteristic coefficient aₗ(k) and the detected voice sounds pitch period P obtained from the adaptive speech analysis unit and the voice pitch decision unit, respectively, to proceed the suppression of the background noise. The background noise suppression unit 104 comprises two rows of tapping delay lines with the length of N, one delay unit with the delay amount of P, an adder line with a length of N+1, one noise shaping filter 51. The input signals are the voice sounds signal Sₙₙ(k), the voice sounds characteristic coefficient aₗ(k), and the voice sounds period P. The output is the enhanced speech sample, Ŝₙ(k). The first tapped delay line saves the previous N voice sounds samples, which are Sₙₙ(k−1),Sₙₙ(k−2), . . . , and Sₙₙ(k−N). The second delay line also stores the last N speech samples, which is delayed beforehand for P samples according to the detected pitch period P, that is, Sₙₙ(k−P),Sₙₙ(k−P−1), . . . Sₙₙ(k−P−N). After that, these two group signals of Sₙₙ(k),Sₙₙ(k−1), . . . Sₙₙ(k−N) and Sₙₙ(k−P),Sₙₙ(k−P−1), . . . Sₙₙ(k−P−N) are summed up and sent into the noise shaping filter 51 along with the voice sounds characteristic coefficient aₗ(k). Since there is a high degree of similarity between the voice sounds signals in these two signals, it is a harmonic addition for the voice sounds; on the other hand, the background noise does not have such kind of similarity. Therefore, it is a non-harmonic addition. Thus, the noise-suppression effect with harmonic addition could be achieved. At the noise shaping filter 51, these N+1 combined samples are filtered according to the following transfer function:

$$H ( z ) = \frac{1 - {\sum }_{j = 1}^{N} {β}^{J} {a}_{J} {z}^{- J}}{1 - {\sum }_{i = 1}^{N} {α}^{i} {a}_{i} {z}^{- i}} \qquad ( 8 )$$

wherein α and β are two constants, 0≦β≦α≦1, and are used to control the shape of the signal spectrum. Since aₗ represents the characteristics of the voice sounds signals, the spectrum of the original signal will be transformed into the shape in similar to that of the voice sounds after the transformation of the noise shaping filter 51. That is, the spectra of the background noise varies with the spectra of the voice sounds signals. This is the so-called masking effect and the benefit of suppression the background noise thus has been achieved. Since we have performed the harmonic addition beforehand, it elevates largely the result of the masking effect.

Next, the voice sounds signals, after being processed by the background noise suppression unit 104, are sent into the high-frequency booster 106.

H_{f}(z)=1−γz⁻¹ (9)

Basically, this is a first order high pass filter, 0<γ<1, which is used to compensate for the influence of high frequency attenuation caused by the noise shaping filter. Finally, it passes through the low pass filter, which is the same as the proceeding one, to remove the noise outside the voice bandwidth.

The suppression system of background noise of voice sounds signals and the method thereof of this invention has the following advantages in comparison with the above-mentioned cited inventions and other traditional technologies:

1. This invention provides one kind of suppression system of background noise of voice sounds and the method thereof wherein on one hand it utilizes one all-pole linear predict filter to re-built the model of voice sounds signals. On the other hand, it detects the pitch period which only exists in the voice sounds signals. Finally, it suppresses the background noise according to the estimated voice sounds signals association coefficients and the pitch periods of the voice sounds signals and further elevates the quality of the voice sounds signals.

2. This invention provides one kind of suppression system of background noise of voice sounds and the method thereof wherein its degree of complexity is relatively low and it requires only one microphone, so it is very suitable to be used in the application of the recently-fast-growing mobile phone and the technology of voice sounds recognition so as to elevate the quality of the voice coding and the recognition rate of the voice sounds.

The above-mentioned detail description of this invention is the concrete explanation of one embodiment aiming at this invention; however, said embodiment is not used to confine the claims of this invention; all the equivalent practice or modification without departing from the spirit of this invention should be included in the claims of this invention.

To sum up, this invention is not only innovative in the idea of the technology field but also increases many effects as mentioned above than the traditional ones which has obeyed the item of the patent law of novelty and improvement, so we apply for this invention according to the patent law in all sincerity to ask for your bureau to approve the patent application of this invention to encourage innovation which we will be thankful to you for your kind help.

Many changes and modifications in the above-mentioned embodiment of the invention can, of course, be carried out without departing from the scope thereof. According, to promote the progress in science and the useful arts, the invention is disclosed and intended to be limited only by the scope of the appended claims.

TABLE 1
reference table of the adaptive stepsize decision unit

| b(n) | b(n-1) | b(n-2) | b(n-3) | a(n) |
|---|---|---|---|---|
| −1 | −1 | −1 | −1 | 2 |
| 1 | 1 | 1 | 1 | 2 |
| −1 | −1 | −1 | 1 | 1 |
| 1 | 1 | 1 | −1 | 1 |
| −1 | 1 | 1 | 1 | 1 |
| 1 | −1 | −1 | −1 | 1 |
| 1 | 1 | −1 | −1 | 0 |
| −1 | −1 | 1 | 1 | 0 |
| −1 | 1 | 1 | −1 | 0 |
| 1 | −1 | −1 | 1 | 0 |
| −1 | −1 | 1 | 1 | 0 |
| 1 | 1 | −1 | −1 | 0 |
| 1 | −1 | 1 | 1 | 0 |
| −1 | 1 | −1 | −1 | 0 |
| −1 | 1 | −1 | 1 | −1 |
| 1 | −1 | 1 | −1 | −1 |

What is claimed is:

1. A suppression method of the voice sounds signals wherein analog voice sounds signals first pass through a sampler to be transformed from analog signals to digital signals comprising the steps of:
a. utilizing 32 KHz sampling frequency to sample and represent the acquired digital signals with 12 bits pulse code modulation;
b. passing a low-pass filter after sampling;
c. removing unnecessary signals outside the bandwidth of the voice sounds signals wherein the digital signals from the first low-pass filter are sent into the adaptive speech analysis unit, pitch detection unit and the background noise suppression filter unit, respectively, to proceed the next-step process;
In adaptive speech analysis unit, the voice sounds signals are estimated by utilizing the N'th order all-pole adaptive filter wherein the coefficient of the all-pole adaptive filter is aₗ(k), i=1,2 . . . N, which represents i'th filter coefficient, these N filter coefficients of which to be determined to represent the unique characteristics of the voice sounds signals will be sent to the background suppression filter unit; on the other hand it will be sent to the pitch detection unit to estimate the pitch periods of the voice sounds wherein each pitch period of samples of the voice sounds will be estimated and be sent to the background noise suppression filter unit to proceed the next-step suppression of the background noise.
In the background noise suppression filter, the background noise suppression filter is designed by utilizing the speech characteristics coefficients and the voice sounds pitch periods and next by utilizing one high-frequency booster to compensate for the attenuated components of its high frequency in the voice sounds signals, finally by utilizing one low-pass filter to remove the noise outside the bandwidth of the voice sounds signals.

2. A suppression system of the background noise of the voice sounds signals wherein unnecessary background noise would be deleted by means of suitably adjustment of the signals according to the variation of the voice sounds signals by means of the long time and the short time statistic characteristics of voice sounds comprising:
An oversampling unit, to transform the analog voice sounds signals into the digital ones;
A first low-pass filter, to remove the unnecessary parts in the digital voice sounds signals of the output from the oversampling unit;
An adaptive speech analysis unit, to analyze the characteristics of the digital voice sounds signals output from said first low-pass filter;
A pitch detection unit which is used to estimate the pitch periods of the digital voice sounds signals output from said first low-pass filter;
A background noise suppression filter which is used to remove the background noise according to the characteristic of the voice sounds analyzed by the adaptive speech analysis unit and the voice sounds pitch periods estimated from the pitch detection unit;
A high-frequency booster which is used to compensate for the attenuation of the digital voice sounds signals caused by the background noise suppression filter;
A second low-pass filter which is used to remove the unnecessary parts of the output of the high frequency booster.
By means of the above-mentioned component, the unnecessary background noise within the voice sounds signals is suppressed.
